(19) United States
(12) Patent Application Publication
(10) Pub. No.: US 2011/0163986 A1
(43) Pub. Date: Jul. 7, 2011

(54) MOBILE DEVICE AND METHOD FOR OPERATING CONTENT DISPLAYED ON TRANSPARENT DISPLAY PANEL

(75) Inventors: Eun Hye LEE, Seoul (KR); Joon Ho WON, Suwon-si (KR); Bo Eun PARK, Seongnam-si (KR); Byeong Cheol HWANG, Seoul (KR)

(73) Assignee: SAMSUNG ELECTRONICS CO. LTD., Suwon-si (KR)

(21) Appl. No.: 12/985,713

(22) Filed: Jan. 6, 2011

Related U.S. Application Data
(60) Provisional application No. 61/335,428, filed on Jan. 6, 2010.

(30) Foreign Application Priority Data
Dec. 27, 2010 (KR) 10-2010-0135745

(51) Int. Cl. G06F 3/041

(52) U.S. Cl. 345/173

(57) ABSTRACT

A mobile device for operating displayed content having a dual touch screen based on a transparent display panel is provided. The mobile device allows a method for operating displayed content in response to a touch event using at least one of front and back faces of the dual touch screen. The mobile device displays the content on the transparent display panel with a predefined brightness. When receiving a touch event through the transparent display panel, the mobile device modifies the brightness of parts or whole of the displayed content in response to the touch event.

### PRIORITY

This application claims the benefit under 35 U.S.C. §119(a) of a Korean patent application filed on Dec. 27, 2010 in the Korean Intellectual Property Office and assigned Ser. No. 10-2010-0135745, and a U.S. provisional patent application filed on Jan. 6, 2010 in the U.S. Patent and Trademark Office and assigned Ser. No. 61/335,428, the entire disclosures of each of which is hereby incorporated by reference.

### BACKGROUND OF THE INVENTION

1. Field of the Invention

The present invention relates to a mobile device having a touch screen. More particularly, the present invention relates to a mobile device and method for operating displayed content in response to a touch event using at least one of front and back faces of the mobile device having a transparent display panel.

2. Description of the Related Art

As well known in the art, a mobile device refers to a type of electronic device based on mobility and portability. With remarkable growths of related technologies, a great variety of mobile devices capable of supporting various end-user functions are increasingly popularized in these days.

Nowadays such mobile devices may employ many input techniques. In particular, some of conventional mobile devices offer a touch-based input interface such as a touch screen that normally includes a touch panel and a display unit. In this case, the mobile device generates a touch event in response to a user's touch input made on the touch panel and then performs a predefined function based on the touch event.

One of advanced touch screens is a dual touch screen in which two touch sensors are disposed on both sides of a display unit formed of a transparent display panel. This dual touch screen can detect a touch event from both sides through the front and back touch sensors. The display unit of the dual touch screen is transparent and hence its transparency varies according to the brightness of displayed colors. Namely, the transparency of the display unit approaches 0% as the colors displayed on the display unit gets near to white. In addition, the transparency of the display unit approaches 100% as the colors displayed on the display unit gets near to black.

However, a conventional mobile device having the transparent display panel is still in a simple stage which allows the background behind the mobile device to be seen through the transparent display panel. More improved and effective user interfaces and their operation methods may be required for the mobile device having the transparent display panel.

### SUMMARY OF THE INVENTION

An aspect of the present invention is to address at least the above-mentioned problems and/or disadvantages and to provide at least the advantages described below. Accordingly, an aspect of the present invention is to provide a mobile device having a touch screen and also to provide a method for operating displayed content using the touch screen.

Another aspect of the present invention is to provide a mobile device having a dual touch screen based on a transparent display panel and also to provide a method for operating displayed content in response to a touch event on the dual touch screen.

Still another aspect of the present invention is to provide an apparatus and method for operating displayed content in response to a touch on the front side, on the back side, or on both sides of a dual touch screen based on a transparent display panel in a mobile device.

Yet another aspect of the present invention is to provide an apparatus and method for modifying the brightness of parts or all of displayed content in response to a touch event on a dual touch screen based on a transparent display panel in a mobile device.

According to an aspect of the present invention, a method for operating displayed content in a mobile device having a transparent display panel is provided. The method includes displaying the content on the transparent display panel with a predefined brightness, receiving a touch event through the transparent display panel, and modifying the brightness of parts or whole of the displayed content in response to the touch event.

According to another aspect of the present invention, a mobile device is provided. The device includes, a touch screen for receiving a touch event and then for modifying the brightness of content in response to the touch event, and a control unit for determining the type of the touch event received from the touch screen and then, in response to the touch event, and for performing a transparentizing process by modifying the brightness of parts or whole of the content displayed on the touch screen.

In various aspects of this invention, the mobile device having the transparent display panel may realize optimal environments for varying the transparency of displayed content according to various touch events. Therefore, this mobile device can offer new additive and useful functions based on the transparent display panel.

According to another aspect of the present invention, a method for operating the displayed content is provided by allowing a user to intuitively modify the brightness of parts or whole of the displayed content through various touch events such as front, back or double-sided touch events. This technique may be favorably and widely applied to any type of device that employs the transparent display panel. The double-sided touch-based changes in transparency of displayed content may promote usability, accessibility and competitiveness of the mobile device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile device having a dual touch screen based on a transparent display panel in accordance with an exemplary embodiment of the present invention.

FIG. 2 is a schematic view illustrating a transparent display panel of a mobile device in accordance with an exemplary embodiment of the present invention.

FIGS. 3 to 5 are schematic views illustrating three types of touch events on a transparent display panel of a mobile device in accordance with exemplary embodiments of the present invention.

FIGS. 6 to 11 are views illustrating various ways to operate content displayed on a display unit in response to a touch event in a mobile device in accordance with exemplary embodiments of the present invention.

FIG. 12 is a flowchart illustrating a method for operating displayed content in response to a touch event on a dual touch screen based on a transparent display panel in a mobile device in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to a mobile device that has a touch screen and executes a method for operating displayed content using the touch screen. More particularly, the mobile device includes a dual touch screen based on a transparent display panel. Additionally, this invention allows the mobile device to perform a particular function in response to a touch event through a touch on the front side, on the back side, or on both sides of the dual touch screen.

Among terms set forth herein, a front touch refers to a touch gesture on the front side of a touch screen, including a single touch and a multi touch. A back touch refers to a touch gesture on the back side of a touch screen, including a single touch and a multi touch. A double-sided touch refers to a multi touch gesture on both sides of a touch screen.

Now, a mobile device according to exemplary embodiments of this invention and its operation control method will be described hereinafter. The following exemplary embodiment is, however, exemplary only and not to be considered as a limitation of this invention. As will be understood by those skilled in the art, any other alternative exemplary embodiments may be favorably used.

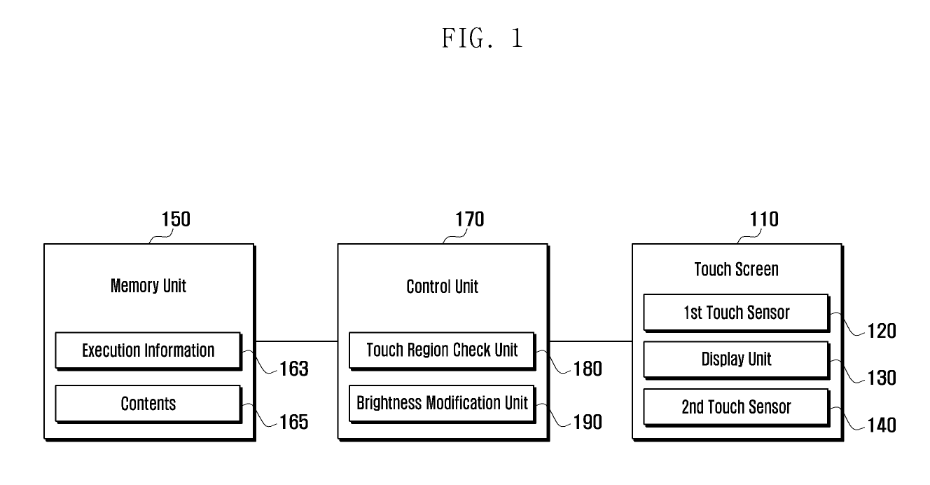

FIG. 1 is a block diagram illustrating a configuration of a mobile device having a dual touch screen based on a transparent display panel in accordance with an exemplary embodiment of the present invention.

Referring to FIG. 1, the mobile device includes a touch screen 110, a memory unit 150 and a control unit 170. Additionally, the mobile device may include an audio processing unit having a microphone and a speaker, a digital broadcast module for receiving and playing digital broadcasting such as Digital Multimedia Broadcasting (DMB) or Digital Video Broadcasting (DVB), a camera module for taking a photo or recording a video, a Bluetooth communication module for performing a Bluetooth communication function, a radio frequency communication module for performing a communication function based on a mobile communication service, an Internet communication module for performing an Internet communication function, a touch pad for a touch-based input, a key input unit for a mechanical key input, a battery for a power supply, and the like. Since these elements are well known in the art, related illustration and description will be omitted herein.

The touch screen 110 includes a first touch sensor 120, a display unit 130, and a second touch sensor 140. Herein, a user-facing side of the display unit 130 is referred to as the front side, and the opposite side is referred to as the back side. The first touch sensor 120 may be disposed on the front side, and the second touch sensor 140 may be disposed on the back side. The first and second touch sensors 120 and 140 may include well known touch-sensitive sensors of capacitive overlay type, resistive overlay type, piezoelectric type, and the like.

The display unit 130 represents an operation state of the mobile device and related data. Under the control of the control unit 170, the display unit 130 may display a variety of contents (e.g., photos, images, lists, text, icons, menus, etc.). Also, under the control of the control unit 170, the display unit 130 may display content modified in response to a touch event that is detected through at least one of the first and second touch sensors 120 and 140. Here, the display unit 130 may display content being partially transparent according to a touch event. Namely, the brightness of content displayed may become different.

For instance, it is supposed that one touch event of a front touch, a back touch and a double-sided touch is inputted when content with a specific image is displayed on the display unit 130.

When a touch event (hereinafter, referred to as a front touch event) is inputted on the front side of the display unit 130, content displayed on the display unit 130 may be modified through the execution of a particular function (e.g., a content move, a content enlargement, a content reduction, a content scroll, a content change, an application correlated with content, etc.) depending on the front touch event.

When a touch event (hereinafter, referred to as a back touch event) is inputted on the back side of the display unit 130, content displayed on the display unit 130 may be modified through the execution of a particular function (e.g., an object erasing of a specific region from which the back touch event is detected, etc.) depending on the back touch event. Here, the region erased from content by the back touch event (namely, the region where the back touch event occurs) may become transparent or have an increased brightness.

When a touch event (hereinafter, referred to as a double-sided touch event) is inputted through correlated regions of on both sides of the display unit 130, content displayed on the display unit 130 may be modified through the execution of a particular function (e.g., a partial focusing of content at a specific region from which the double-sided touch event is detected, a partial cutting of content at a specific region from which the double-sided touch event is detected, etc.) depending on the double-sided touch event. Here, all regions except the focused region may become transparent or have an increased brightness. Otherwise, the focused region only may become transparent or have an increased brightness. In addition, the cut region may become transparent or have an increased brightness.

Each of the first and second touch sensors 120 and 140 may detect a touch event inputted by a certain input tool such as a user's finger on the surface of the touch screen 110. Then the first and second touch sensors 120 and 140 may find the coordinates of a detection region of the touch event and send them to the control unit 170. As discussed above, the first and second touch sensors 120 and 140 may be disposed on the front and back sides of the display unit 130, respectively. Therefore, the first and second touch sensors 120 and 140 may be referred to as a front touch sensor and a back touch sensor, respectively. When a user takes an input gesture (e.g., a touch, a drag, a tap, etc.) with the finger on the front side of the display unit 130, the front touch sensor 120 may detect the front touch event corresponding to the input gesture. When a user takes an input gesture (e.g., a touch, a drag, a tap, etc.) with the finger on the back side of the display unit 130, the back touch sensor 140 may detect the back touch event corresponding to the input gesture. When a user takes a simultaneous input gesture (e.g., a multi touch, a multi drag, a multi tap, etc.) with two fingers on both sides of the display unit 130, the front and back touch sensors 120 and 140 may simultaneously detect the front and back touch events, i.e., the double-sided touch event, corresponding to the input gesture.

Meanwhile, a touch event may refer to a particular input gesture such as a touch, a touch move (e.g., a drag), or a touch and release (e.g., a tap), which may be detected through at least one of the front and back touch sensors 120 and 140.

The memory unit 150 stores a variety of programs and data executed and processed in the mobile device and may be formed of at least one of a non-volatile memory, such as a Read Only Memory (ROM) or a flash memory, and a volatile memory such as a Random Access Memory (RAM). The memory unit 150 may permanently or temporarily store an operating system of the mobile device, programs and data in connection with display control operations of the display unit 130, programs and data in connection with input control operations of the first and second touch sensors 120 and 140, programs and data in connection with a transparentizing process of the display unit 130, and the like.

Additionally, the memory unit 150 may store execution information 163 including a relation between particular functions and touch event types (i.e., a front touch event, a back touch event, and a double-sided touch event), and setting values for the brightness of content to be modified in response to a touch event. Also, the memory unit 150 may store various contents 165 to be displayed on the display unit 130. Here, setting values of content brightness may vary from 0% to 100%.

The control unit 170 controls general states and operations of the mobile device. Particularly, the control unit 170 may control the operation of content in response to a touch event detected through the touch screen 110. For instance, the control unit 170 may modify displayed content in response to at least one touch event delivered from the first and second touch sensors 120 and 140. Here, the control unit 170 may check a region from which a touch event is detected, and then determine whether the detected region is on the front side, on the back side, or on both sides of the display unit 130. Also, for each touch event, the control unit 170 may change the transparency of a partial or whole region of content according to a predefined brightness.

The control unit 170 may include a touch region check unit 180 that identifies a specific region of a touch event delivered from the front and back touch sensors 120 and 140, and a brightness modification unit 190 that modifies the brightness of content according to a touch event.

The touch region check unit 180 may identify a specific region on which a touch event is inputted, by finding coordinates of a touched region from a touch signal received from the touch screen 110. Namely, the touch region check unit 180 may receive a touch signal from at least one of the front and back touch sensors 120 and 140 and then identify a touch region by using its coordinates. More specifically, through coordinates received from the touch screen 110, the touch region check unit 180 may determine whether a touch event occurs on the front side, on the back side, or on both sides of the display unit 130. Additionally, by using the coordinates received from the touch screen 110, the touch region check unit 180 may determine whether a touch input is moved across the surface of the touch screen 110. Also, by using the coordinates received from the touch screen 110, the touch region check unit 180 may determine the size of a touch region.

The brightness modification unit 190 may increase or decrease the brightness of displayed content according to predefined levels of a touch event. Namely, the brightness modification unit 190 may receive information about a touch event from the touch region check unit 180 and then perform a transparentizing process to change the brightness of displayed content depending on the level of the received touch event. For instance, if the brightness of certain content is set to 0%, the brightness modification unit 190 may change the brightness of a selected partial region or the whole region of content from 1% to 100%.

As discussed heretofore, the control unit 170 may identify a touch event through the touch region check unit 180 and then, based thereon, change the brightness of content displayed on the display unit 130 to a predefined brightness corresponding to the identified touch event through the brightness modification unit 190. Control operations of the control unit 170 will be described later.

Besides, the control unit 170 can control various operations in connection with typical functions of the mobile device. For instance, the control unit 170 may control the operation and data display of a running application. Also, the control unit 170 may receive an input signal through various touch-based input interfaces and then control the execution of a corresponding function. And also, the control unit 170 may control transmission and reception of data based on a wired or wireless communication.

Meanwhile, the mobile device shown in FIG. 1 may include communication devices, multimedia players and their application equipment, each of which has a touch screen based on a transparent display panel. For instance, the mobile device may include many types of mobile communication terminals based on various communication protocols, a tablet PC, a smart phone, a Portable Multimedia Player (PMP), a digital broadcasting player, a Personal Digital Assistant (PDA), a portable game console, and the like. Also, a content operation method using the transparent display panel according to this invention may be applied to a monitor, a notebook, a TV, a Large Format Display (LFD), a Digital Signage (DS), a media pole, etc.

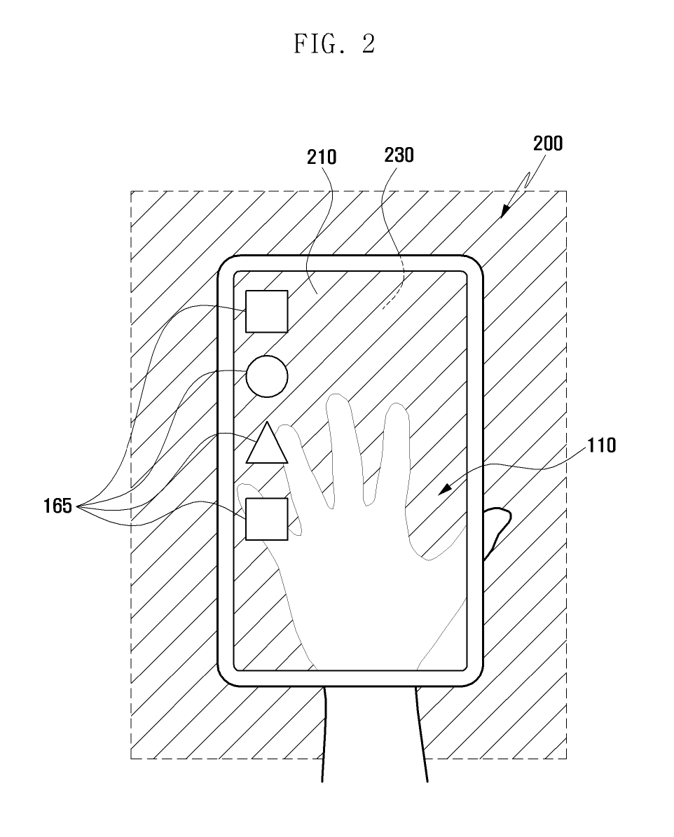

FIG. 2 is a schematic view illustrating a transparent display panel of a mobile device in accordance with an exemplary embodiment of the present invention.

Referring to FIG. 2, the mobile device has the touch screen 110 which is formed of a transparent display panel. Therefore, the touch screen 110 allows a background 200 behind the mobile device to be shown through the transparent display panel. Namely, the brightness more than 0% is assigned to the display unit 130, so the background 200 can be seen according to a degree of transparency depending on the brightness. For instance, as the brightness approaches 0%, the color displayed on the display unit 130 gets near to white. Namely, transparency becomes lower. On the contrary, as the brightness approaches 100%, the color displayed on the display unit 130 gets near to black. Namely, transparency becomes higher. Contents displayed on the display unit 130 may be basically set to the brightness of 0% and the lowest transparency.

In the drawings, the background 200 is expressed as diagonal lines. However, actually, the background 200 may be appearances of real things that are seen through the transparent display panel.

Meanwhile, as discussed above, the touch screen 110 includes two touch sensors 120 and 140 and the display unit 130. The touch sensors 120 and 140 may be attached to both sides 210 and 230 of the display unit 130, respectively. Herein, a user-facing side 210 of the display unit 130 is referred to as the front side, and the opposite side 230 is referred to as the back side. Also, the touch sensor disposed on the front side 210 is referred to as a front touch sensor 120, and the touch sensor disposed on the back side 230 is referred to as a back touch sensor 140. According to an exemplary embodiment of this invention, the mobile device may control the operation of the content 165 displayed on the display unit 130, depending on a touch event detected through at least one of the front and back touch sensors 120 and 140. Related examples will be described later.

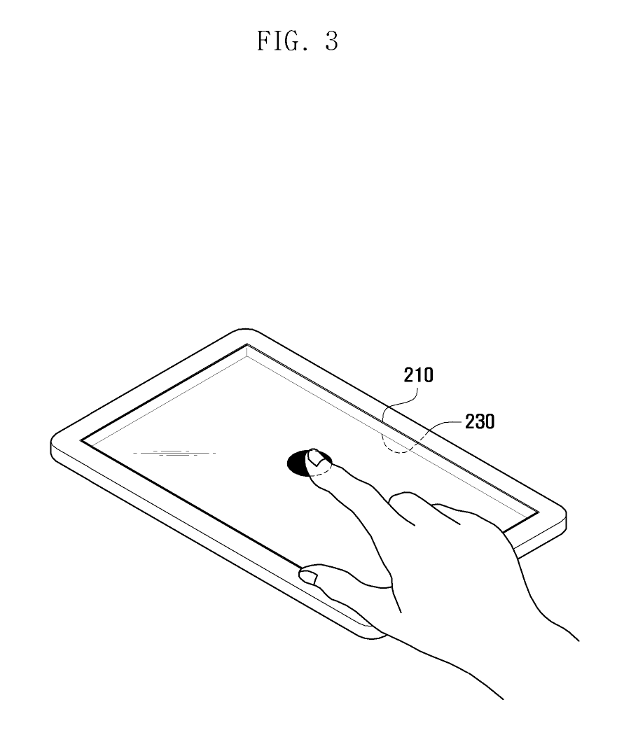

FIGS. 3 to 5 are schematic views illustrating three types of touch events on a transparent display panel of a mobile device in accordance with exemplary embodiments of the present invention.

Referring to FIG. 3, while certain contents are displayed on the display unit 130, a user may input a front touch event by touching (or dragging, tapping, etc.) a selected region with the finger on the front side 210 of the display unit 130. Then the front touch sensor 120 finds the coordinates of the region from which the front touch event is detected, and sends them to the control unit 170. Thus the control unit 170 controls the execution of a particular function according to the front touch event. Functions executed by the front touch event may be to move, enlarge, reduce, or scroll the content selected by the front touch event or to draw or input a certain object (e.g., a line, a figure, text, etc.) depending on the front touch event.

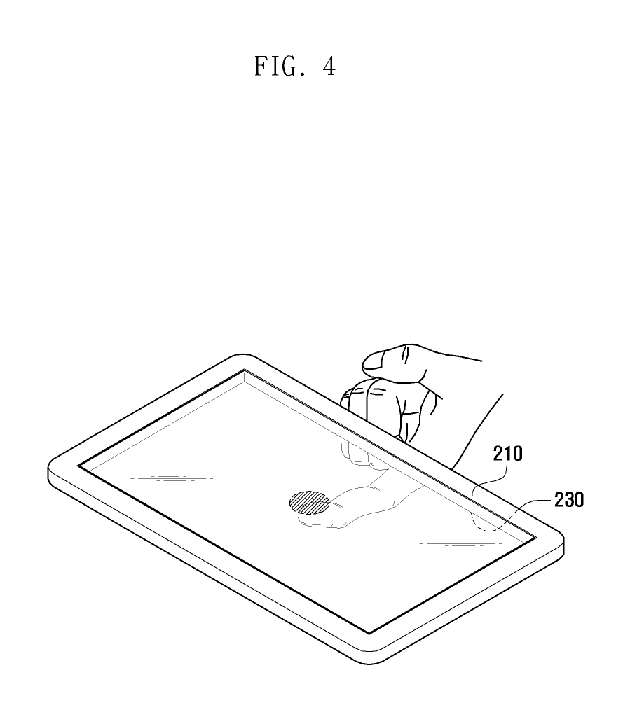

Referring to FIG. 4, while certain contents are displayed on the display unit 130, a user may input a back touch event by touching (or dragging, tapping, etc.) a selected region with the finger on the back side 230 of the display unit 130. Then the back touch sensor 140 finds the coordinates of the region from which the back touch event is detected, and sends them to the control unit 170. Thus the control unit 170 controls the execution of a particular function according to the back touch event. Functions executed by the back touch event may be to erase or remove the content or object selected by the back touch event. Erasing the content may include a process of transparentizing a specific region, on which the back touch event is inputted, in the content according to a predefined brightness. Also, removing the object may include partially or completely removing the object (e.g., a line, a figure, text, etc.) that is drawn or inputted by the front touch event.

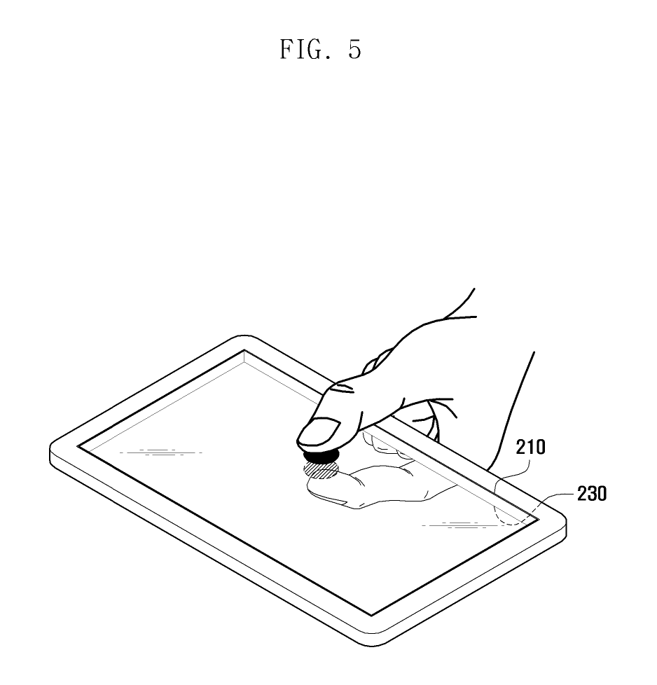

Referring to FIG. 5, while certain contents are displayed on the display unit 130, a user may input a double-sided touch event by simultaneously touching (or dragging, tapping, etc.) selected regions with the fingers on the front and back sides 210 and 230 of the display unit 130. Then each of the front and back touch sensors 120 and 140 finds the coordinates of each region from which the double-sided touch event is detected, and sends them to the control unit 170. Thus the control unit 170 controls the execution of a particular function according to the double-sided touch event. Functions executed by the double-sided touch event may be to focus or cut parts of the content selected by the double-sided touch event. Focusing the content may include a process of transparentizing, depending on a predefined brightness, all regions in the content except a specific region on which the double-sided touch event is inputted. Also, cutting the content may include a process of transparentizing a cut region in the content, depending on a predefined brightness.

As discussed heretofore, the transparency of the display unit 130 may be varied according to the brightness of displayed colors. In other words, the transparency becomes lower as colors with a higher brightness are displayed on the display unit 130. On the contrary, the transparency becomes higher as colors with a lower brightness are displayed on the display unit 130. Therefore, the display unit 130 with a higher transparency allows the background behind the mobile device to be seen, and vice versa. Herein, a color with a higher brightness approaches a white, and a color with a lower brightness approaches a black.

Now, examples of modifying the brightness of displayed content in response to a touch event inputted in the mobile device will be described. In the initial state, all contents displayed on the display unit may be transparent to allow the background to be seen or may be opaque to disallow the background to be seen. Alternatively, some contents may be transparent and the others may be opaque.

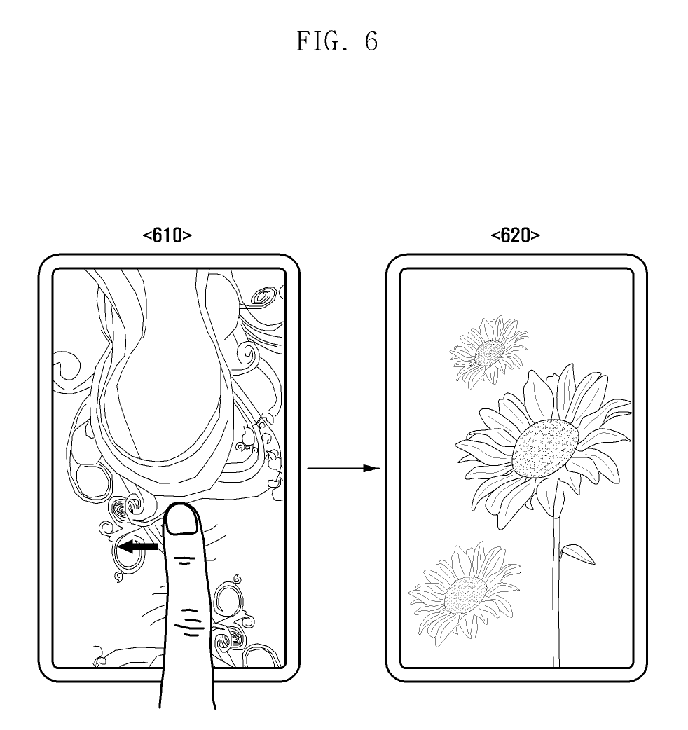

FIG. 6 is a view illustrating a way to operate content displayed on a display unit in response to a touch event in a mobile device in accordance with an exemplary embodiment of the present invention. More particularly, FIG. 6 shows an example of operating displayed content in response to the front touch event.

Referring to FIG. 6, in an initial stage 610, the display unit 130 represents opaque contents (0% brightness) such as image or photo contents.

In the initial stage 610, a user may input a front touch event on the front side 210 of the display unit 130. For instance, as shown, a user may touch a certain region with the finger on the front side 210 of the display unit 130 and then moves leftward the finger.

Then the front touch event is detected through the front touch sensor 120, and the control unit 170 modifies the displayed content in response to the front touch event. For instance, as shown in a next stage 620, the display unit 130 may represent another content changed by the front touch event.

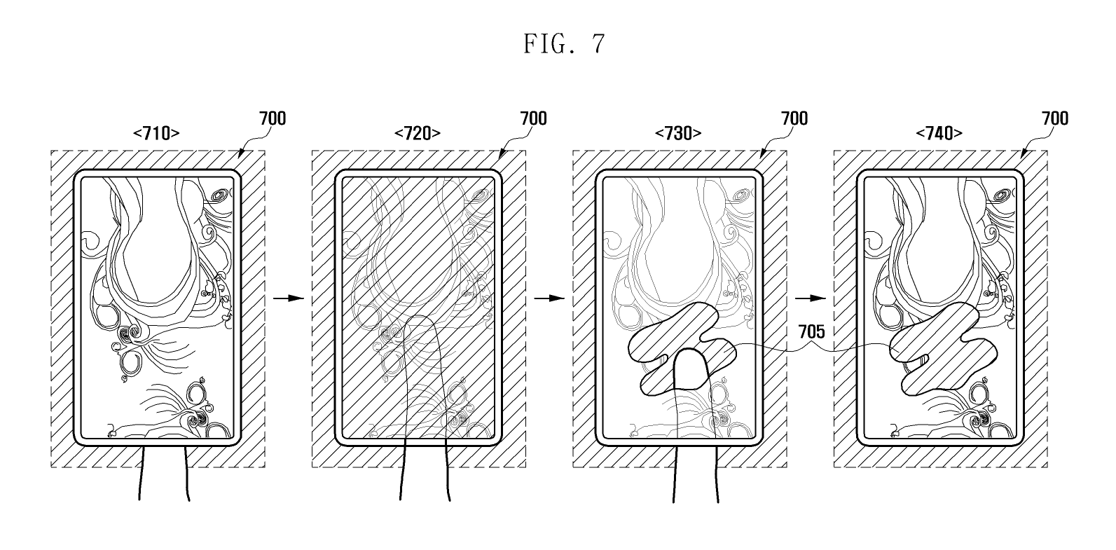

FIG. 7 is a view illustrating a way to operate content displayed on a display unit in response to a touch event in a mobile device in accordance with an exemplary embodiment of the present invention. More particularly, FIG. 7 shows an example of transparentizing a part of displayed content in response to the back touch event.

Referring to FIG. 7, in a first stage 710, the display unit 130 represents opaque contents (0% brightness) such as calendar content. In FIG. 7, a background 700 is simply expressed as diagonal lines. However, actually, the background 700 may be appearances of real things that are seen through the transparent display panel.

In the first stage 710, a user may input the first back touch event on the back side 230 of the display unit 130. For instance, as shown in the first stage 710 and a second stage 720, a user may touch a certain region with the finger on the back side 230 of the display unit 130 and wait for a while.

Then the first back touch event is detected through the back touch sensor 140, and the control unit 170 modifies the displayed content in response to the first back touch event. For instance, as shown in the second stage 720, the display unit 130 may represent the content modified through a transparentizing process with a given brightness (e.g., 50% brightness, i.e, semitransparent) by the first back touch event. The semitransparent content in this stage 720 allows a user to conveniently and exactly input the second back touch event. So, this state 720 may be omitted.

The occurrence of the first back touch event for the semitransparent content requires an input that continues for a given time. Similarly, the release of the back touch event may require a given waiting time for an input of the next back touch event as shown in a third stage 730. If there is no back touch event for a given time, the semitransparent content may return to the original state.

In the second stage 720, a user may input the second back touch event on the back side 230 of the display unit 130. For instance, as shown in the third stage 730, a user may scratch a certain region in the displayed content.

Then the second back touch event is detected through the back touch sensor 140, and the control unit 170 modifies the displayed content in response to the second back touch event. For instance, as shown in the third stage 730, the display unit 130 may represent a scratched part 705 of the content modified through a transparentizing process with a given brightness (e.g., 100% brightness) by the second back touch event.

Next, in the third stage 730, a user may release the second touch event inputted on the back side 230 of the display unit 130. Then the release of the second back touch event is detected through the back touch sensor 140, and the control unit 170 modifies the displayed content in response to the release of the second back touch event. For instance, as shown in a fourth stage 740, the display unit 130 may represent the scratched part 705 only as being transparent by the second back touch event, while keeping the original brightness (e.g., 0% brightness) of the other parts in the displayed content.

If the stage 720 is omitted as discussed above, this stage 740 may also be omitted. Namely, in the first stage 710, the scratched part 705 may be directly transparentized in response to the second back touch event.

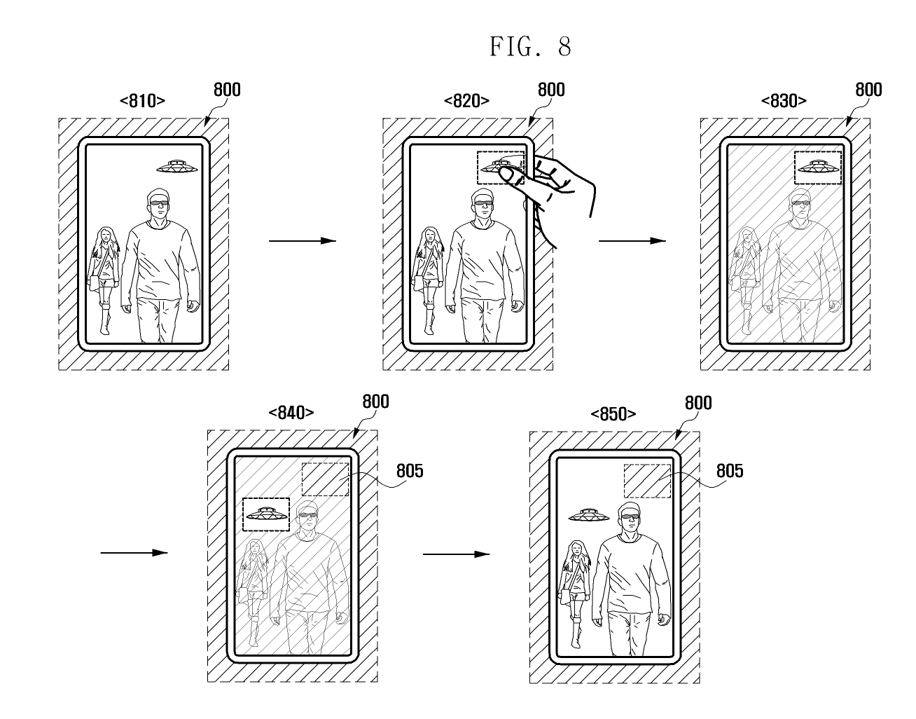

FIG. 8 is a view illustrating a way to operate content displayed on a display unit in response to a touch event in a mobile device in accordance with an exemplary embodiment of the present invention. More particularly, FIG. 8 shows an example of cutting and transparentizing a part of displayed content in response to the double-sided touch event.

Referring to FIG. 8, in a first stage 810, the display unit 130 represents opaque contents (0% brightness) such as photo content. In FIG. 8, a background 800 is simply expressed as diagonal lines. However, actually, the background 800 may be appearances of real things that are seen through the transparent display panel.

In the first stage 810, a user may input the first double-sided touch event on both sides 210 and 230 of the display unit 130. For instance, as shown in a second stage 820, a user may touch coinciding regions with the fingers on both sides 210 and 230 of the display unit 130 and wait for a while.

Then the first double-sided touch event is detected through the front and back touch sensors 120 and 140, and the control unit 170 modifies the displayed content in response to the first double-sided touch event. For instance, as shown in a third stage 830, the display unit 130 may transparentize all regions with a given brightness (e.g., 50% brightness, i.e., semitransparent) except a specific region selected by the first double-sided touch event. This stage 830 is required only to promote a user's visibility and therefore may be omitted.

In the third stage 830, a user may input the second double-sided touch event on both sides of the display unit 130. For instance, as shown in the fourth stage 840, a user may move a specific region selected by the first double-sided touch event to another position.

Then the second double-sided touch event is detected through the front and back touch sensors 120 and 140, and the control unit 170 modifies the displayed content in response to the second double-sided touch event. For instance, as shown in a fourth stage 840, the region selected by the first double-sided touch event is cut and moved in response to the second double-sided touch event. At this time, a semitransparent state of regions other than the selected region may be maintained. Also, a cut part 805, i.e., the original position of the selected region, may be transparentized with a given brightness (e.g., 100% brightness).

Next, in the fourth stage 840, a user may release the second touch event inputted on both sides 210 and 230 of the display unit 130. Then the release of the second double-sided touch event is detected through the front and back touch sensors 120 and 140, and the control unit 170 modifies the displayed content in response to the release of the second double-sided touch event. For instance, as shown in a fifth stage 850, the display unit 130 may represent the cut and moved part 805 at a new position. At this time, the display unit 130 may keep the transparency of the cut and moved part 805 and also returns the other parts of semitransparent content to the original brightness (e.g., 0% brightness).

If the third stage 830 is omitted as discussed above, this stage 850 may also be omitted. Namely, in the second stage 820, the cut part 805 may be directly transparentized in response to the first and second double-sided touch events.

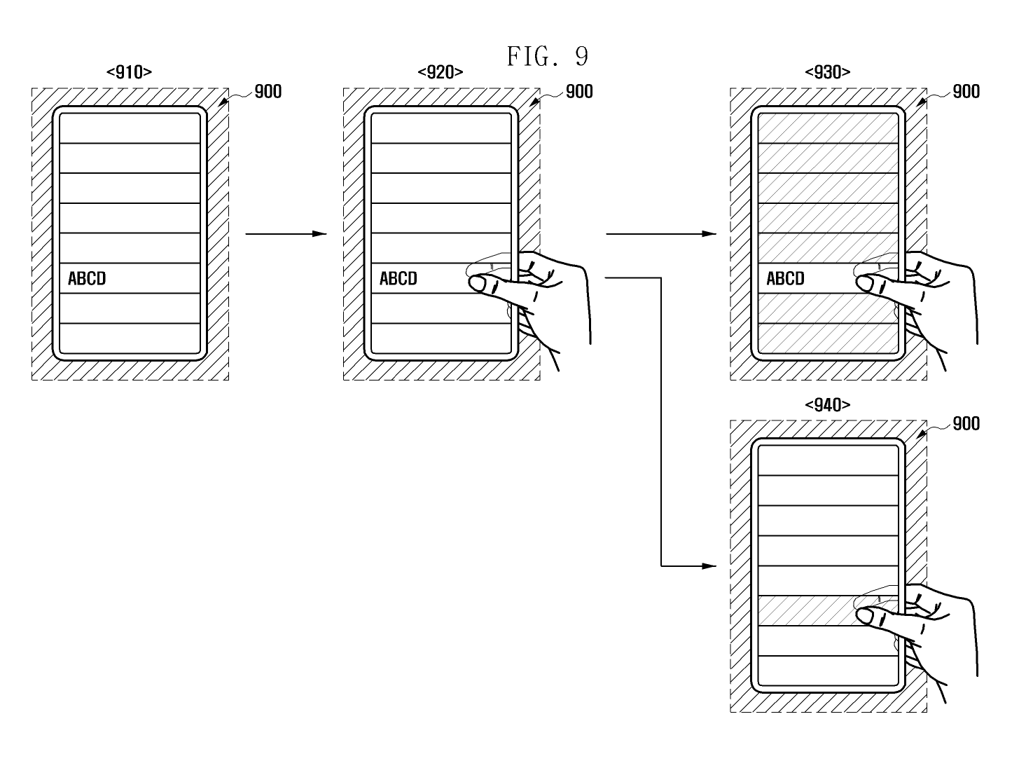

FIG. 9 is a view illustrating a way to operate content displayed on a display unit in response to a touch event in a mobile device in accordance with an exemplary embodiment of the present invention. More particularly, FIG. 9 shows an example of focusing and transparentizing a part of displayed content in response to the double-sided touch event.

Referring to FIG. 9, in a first stage 910, the display unit 130 represents opaque contents (0% brightness) such as message list content. In FIG. 9, a background 900 is simply expressed as diagonal lines. However, actually, the background 900 may be appearances of real things that are seen through the transparent display panel.

In the first stage 910, a user may input a double-sided touch event on both sides 210 and 230 of the display unit 130. For instance, as shown in a second stage 920, a user may touch coinciding regions with the fingers on both sides 210 and 230 of the display unit 130 and wait for a while.

Then the double-sided touch event is detected through the front and back touch sensors 120 and 140, and the control unit 170 modifies the displayed content in response to the double-sided touch event. For instance, as shown in a third stage 930, the display unit 130 may transparentize all regions with a given brightness (e.g., a certain brightness between 1% and 100%) except a specific region (e.g., a specific item in the message list) selected by the double-sided touch event. Alternatively, as shown in a fourth stage 940, the display unit 130 may transparentize a specific region (e.g., a specific item in the message list) selected by the double-sided touch event with a given brightness (e.g., a certain brightness between 1% and 100%).

Like this, a part (referred to as an object) of the displayed content selected by the double-sided touch event may be transparentized with a predefined brightness, or the other region except the selected object may be transparentized with a predefined brightness. This option of a transparentizing process may rely on a user's setting.

Although not illustrated in FIG. 9, a further double-sided touch event (e.g., an event of moving or copying the selected object to other position in the list) may be inputted after the third or fourth stage 930 or 940 as discussed in FIG. 8.

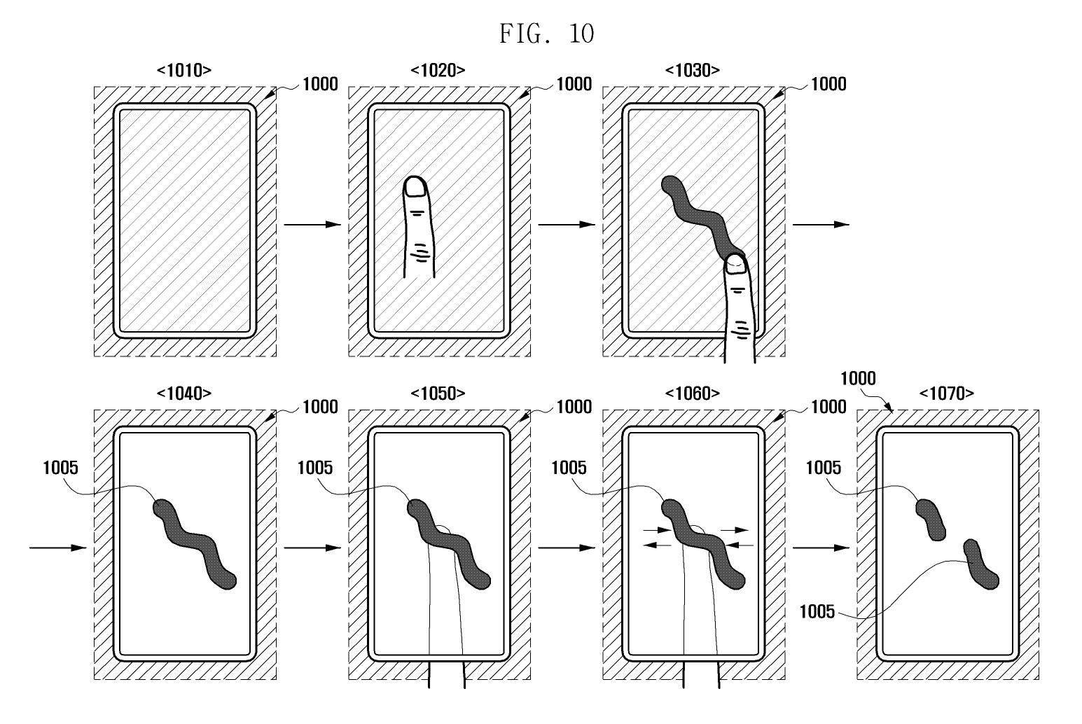

FIG. 10 is a view illustrating a way to operate content displayed on a display unit in response to a touch event in a mobile device in accordance with an exemplary embodiment of the present invention. More particularly, FIG. 10 shows an example in which content is created in response to the front touch event and then operated in response to the back touch event.

Referring to FIG. 10, in a first stage 1010, the display unit 130 has a predefined brightness (e.g., certain brightness between 1% and 100%) and hence allows a background 1000 to be seen through the transparent display panel. Although no content is displayed on the display unit 130 in FIG. 10, any opaque content may be displayed on the whole or parts of the display unit 130 as discussed above. In FIG. 10, the background 1000 is simply expressed as diagonal lines. However, actually, the background 1000 may be appearances of real things that are seen through the transparent display panel.

In the first stage 1010, a user may input a front touch event on the front side 210 of the display unit 130. For instance, as shown in a second stage 1020, a user may touch a specific region with the finger on the front side 210 of the display unit 130 and then, as shown in a third stage 1030, move the touch across the front side 210. Namely, a user may perform a drawing through the front touch event on the front side 210 of the display unit 130.

In other words, specific content may be created depending on the front touch event. For instance, as shown in a fourth stage 1040, zigzag-shaped content 1005 may be drawn on the display unit 130 by using the front touch event. This content 1005 may be different from the former content that has been already offered to the display unit 130 with a predefined brightness.

Then, in the fourth stage 1040, a user may input a back touch event on the back side 230 of the display unit 130. For instance, as shown in a fifth stage 1050, a user may touch a specific region with the finger on the back side 230 of the display unit 130 and then, as shown in a sixth stage 1060, move the touch across the back side 230. Namely, a user may perform an erasing through the back touch event on the back side 230 of the display unit 130.

In other words, specific content 1005 may be created in response to the front touch event and then partially or completely erased in response to the back touch event. For instance, as shown in a seventh stage 1070, a part of the displayed content 1005 may be erased from the display unit 130 through the back touch event. Namely, a selected part of the content 1005 may be transparentized by the back touch event.

Although not illustrated, a text input process may be supported according to the content operation method as shown in FIG. 10.

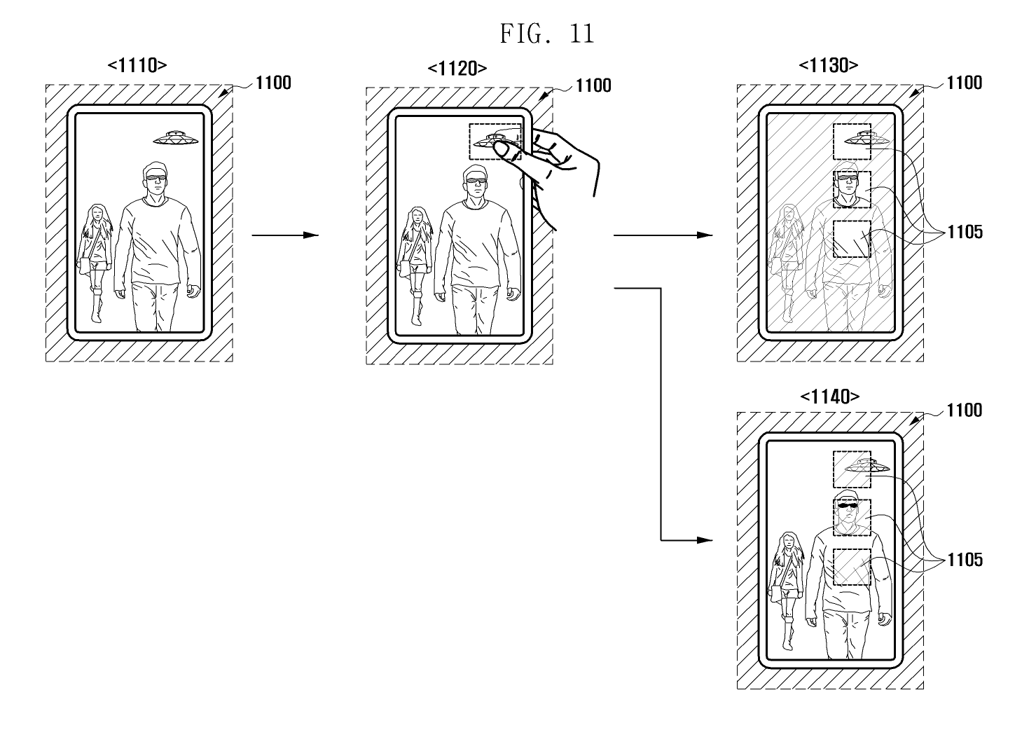

FIG. 11 is a view illustrating a way to operate content displayed on a display unit in response to a touch event in a mobile device in accordance with an exemplary embodiment of the present invention. More particularly, FIG. 11 shows an example of selecting and transparentizing several regions in displayed content in response to the front touch event, the back touch event, or the double-sided touch event.

Referring to FIG. 11, in a first stage 1110, the display unit 130 represents opaque contents (0% brightness) such as photo content. In FIG. 11, a background 1100 is simply expressed as diagonal lines. However, actually, the background 1100 may be appearances of real things that are seen through the transparent display panel.

In the first stage 1110, a user may input one type of touch event (e.g., the front touch event, the back touch event, or the double-sided touch event) on at least one of the front and back sides 210 and 230 of the display unit 130. For instance, as shown in a second stage 1120, a user may simultaneously touch two regions with the fingers on both sides 210 and 230 of the display unit 130. In this case, a user may repeatedly input the double-sided touch event. Namely, a user may sequentially input several touch events on several regions.

Then the double-sided touch event is detected through the front and back touch sensors 120 and 140, and the control unit 170 modifies the displayed content in response to the double-sided touch event. For instance, as shown in a third stage 1130, the display unit 130 may transparentize all regions with a given brightness (e.g., certain brightness between 1% and 100%) except several regions 1105 selected by several touch events. Alternatively, as shown in a fourth stage 1140, the display unit 130 may transparentize several regions 1105 selected by several touch events with a given brightness (e.g., certain brightness between 1% and 100%).

Like this, two or more regions may be selected by the front touch event, the back touch event or the double-sided touch event. Also, the selected regions may be transparentized with a predefined brightness, or the other region except the selected regions may be transparentized with a predefined brightness. This option of a transparentizing process may rely on a user's setting. Besides, a transparentizing process for several regions may be performed sequentially whenever each region is selected or performed at once after all regions are selected.

Although not illustrated in FIG. 11, a further touch event (e.g., an event of moving or copying the selected several objects to other positions) may be inputted after the third or fourth stage 1130 or 1140 as discussed earlier.

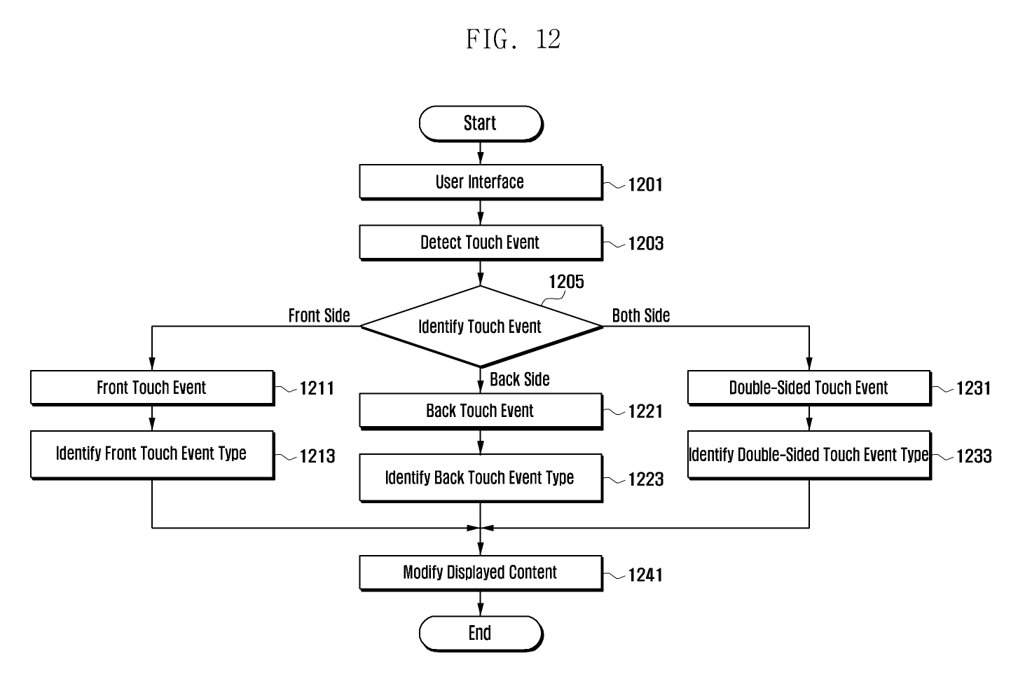

FIG. 12 is a flowchart illustrating a method for operating displayed content in response to a touch event on a dual touch screen based on a transparent display panel in a mobile device in accordance with an exemplary embodiment of the present invention.

Referring to FIG. 12, the control unit 170 displays a user interface by a user's selection in step 1201. The user interface may have a predefined brightness (e.g., 100%) and thus allow the background to be seen through the display unit 130 based on the transparent display panel. Alternatively, the user interface may represent various contents such as photos, icons, menus, lists, etc. or screen data a running application such as a web browser. Namely, the user interface in exemplary embodiments of this invention may include all types of screens regardless of being transparent or not. In FIG. 12, it is supposed that the user interface is the second case of the above three cases. Namely, at least one content is displayed on the display unit 130.

Next, the control unit 170 detects a touch event in step 1203. For instance, the control unit 170 may determine whether a given touch event is detected through the touch screen 110. In this step, the control unit 170 may detect one of the front touch event, the back touch event and the double-sided touch event through at least one of the front and back touch sensors 120 and 140.

Next, the control unit 170 identifies the detected touch event in step 1205. For instance, the control unit 170 may find a specific region from which the touch event is detected, by using the touch region check unit 180. Namely, the control unit 170 may determine whether the detected region of the touch event is on the front side, on the back side or on both sides of the display unit 130.

If the touch event is inputted on the front side of the display unit 130, the control unit 170 recognizes the touch event as a front touch event in step 1211. Then the control unit 170 identifies the type of the front touch event in step 1213 and modifies the displayed content according to the type of the front touch event in step 1241. For instance, if the type of the front touch event is to move the displayed content, the control unit 170 may transfer the content across the display unit 130 depending on the front touch event. Also, if the type of the front touch event is to draw or input text, the control unit 170 may create the content on the display unit 130 depending on the front touch event. And also, if the type of the front touch event is to modify the brightness, the control unit 170 may change the brightness of a specific region selected by the front touch event, of a non-selected region, or of the displayed content depending on the front touch event. Here, changes in brightness may be performed by the brightness modification unit 190 according to predefined levels of a touch event. Related examples in connection with the front touch event have been already discussed with reference to FIGS. 3, 6 and 11.

On the other hand, if the touch event is inputted on the back side of the display unit 130, the control unit 170 recognizes the touch event as a back touch event in step 1221. Then the control unit 170 identifies the type of the back touch event in step 1223 and modifies the displayed content according to the type of the back touch event in step 1241. For instance, if the type of the back touch event is to input at least one region of the displayed content for a while, the control unit 170 may modify the brightness of the content. Also, if the type of the back touch event is to select at least one region of the displayed content, the control unit 170 may modify the brightness of the selected or non-selected region in the content. And also, if the type of the back touch event is to erase the displayed content, the control unit 170 may transparentize a specific region selected by the back touch event. Here, changes in brightness may be performed by the brightness modification unit 190 according to predefined levels of a touch event. Related examples in connection with the back touch event have been already discussed with reference to FIGS. 4, 7, 10 and 11.

On the other hand, if the touch event is inputted on both sides of the display unit 130, the control unit 170 recognizes the touch event as a double-sided touch event in step 1231. Then the control unit 170 identifies the type of the double-sided touch event in step 1233 and modifies the displayed content according to the type of the double-sided touch event in step 1241. For instance, if the type of the double-sided touch event is to input at least one region of the displayed content for a while, the control unit 170 may modify the brightness of the content. Also, if the type of the double-sided touch event is to select at least one region of the displayed content, the control unit 170 may modify the brightness of the selected or non-selected region in the content. And also, if the type of the double-sided touch event is to cut a part of the displayed content, the control unit 170 may transparentize a cut region selected by the double-sided touch event. Here, changes in brightness may be performed by the brightness modification unit 190 according to predefined levels of a touch event. Related examples in connection with the double-sided touch event have been already discussed with reference to FIGS. 5, 8, 9 and 11.

The above-described methods according to the present invention can be implemented in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A method for operating displayed content in a mobile device having a transparent display panel, the method comprising:
displaying the content on the transparent display panel with a predefined brightness;
receiving a touch event through the transparent display panel; and
modifying the brightness of parts or whole of the displayed content in response to the touch event.

2. The method of claim 1, wherein the displaying of the content includes:
representing one of transparent content with the predefined brightness in order to allow a background to be seen, non-transparent content on the entire screen, and both transparent content and non-transparent content in order to allow the background to be partially seen.

3. The method of claim 2, wherein the receiving of the touch event includes:
receiving one of a front touch event, a back touch event and a double-sided touch event through at least one of the front and back sides of a display unit.

4. The method of claim 3, wherein the representing includes:
performing one of a transparentizing process by modifying the brightness of a specific region corresponding to the touch event in the displayed content; and a transparentizing process by modifying the brightness of all regions except the specific region corresponding to the touch event in the displayed content.

5. The method of claim 3, wherein the representing includes:
cutting a specific region selected by the touch event; and
performing a transparentizing process by modifying the brightness of the cut region in the content.

6. The method of claim 3, wherein the representing includes:
performing one of a transparentizing process by modifying the brightness of two or more specific regions selected by the touch event; and a transparentizing process by modifying the brightness of all regions except the two or more specific regions selected by the touch event in the displayed content.

7. The method of claim 3, wherein the representing includes:
creating and representing content in response to the first touch event; and
performing a transparentizing process by modifying the brightness of parts or whole of the created content in response to the second touch event.

8. The method of claim 7, wherein the created content is drawn or inputted and is different from the displayed content, depending on the predefined brightness.

9. A mobile device comprising:
a touch screen for receiving a touch event and then for modifying the brightness of content in response to the touch event; and
a control unit for determining the type of the touch event received from the touch screen and then, in response to the touch event, for performing a transparentizing process by modifying the brightness of parts or whole of the content displayed on the touch screen.

10. The mobile device of claim 9, wherein the touch screen includes:
a display unit for displaying the content modified in response to the touch event;
a front touch sensor disposed on the front side of the display unit and for receiving the touch event; and
a back touch sensor disposed on the back side of the display unit and for receiving the touch event.

11. The mobile device of claim 10, wherein the touch event includes:
a front touch event detected by the front touch sensor;
a back touch event detected by the back touch sensor; and
a double-sided touch event detected by both the front and back touch sensors.

12. The mobile device of claim 10, wherein the control unit modifies the brightness of parts or whole of the displayed content in response to the front touch event, the back touch event or the double-sided touch event.

13. The mobile device of claim 12, wherein the control unit performs a transparentizing process by modifying the brightness of at least one specific region corresponding to the touch event in the displayed content, by modifying the brightness of all regions except the at least one specific region corresponding to the touch event in the displayed content, or by modifying the brightness of a specific region selected by the touch event and cut in the displayed content.

14. The mobile device of claim 12, wherein the control unit creates and represents content in response to the first touch event, and performs a transparentizing process by modifying the brightness of parts or whole of the created content in response to the second touch event.

15. The mobile device of claim 11, wherein the control unit includes:
a touch region check unit for identifying a specific region on which the touch event is inputted, by finding coordinates of a touched region from a touch signal received from at least one of the front and second touch sensors; and
a brightness modification unit for increasing or decreasing the brightness of the displayed content according to predefined levels of the touch event identified by the touch region check unit.
